(19) United States
(12) Patent Application Publication
(10) Pub. No.: US 2009/0287465 A1
(43) Pub. Date: Nov. 19, 2009

(54) Core Hopping

(76) Inventors: Peter S. Shenkin, New York, NY (US); Richard A. Friesner, New York, NY (US); Jay L. Banks, South Orange, NJ (US)

Correspondence Address: FISH & RICHARDSON PC, P.O. BOX 1022, MINNEAPOLIS, MN, 55440-1022, US

(21) Appl. No.: 12/120,615

(22) Filed: May 14, 2008

(51) Int. Cl. G06G 7/58

(52) U.S. Cl. 703/12

(57) ABSTRACT

An optimized compound is derived from a reference compound by replacing its core, or central portion, with a new core. Criteria for accepting a candidate replacement core include said candidate replacement core's ability to connect to the side chains of the reference compound in a chemically reasonable geometry that closely approximates the geometry which said side chains exhibited in the reference compound. The replacement core that substitutes for the core of a reference compound may be extended by linker groups (for example, methylene groups), if said extension improves the achievable alignment of attachment bonds with those of the reference compound over the alignment that could be achieved without the use of linkers. This is done in a single stage, without a combinatorial testing of the number of linkers to be used in the various attachment bonds.

### TECHNICAL FIELD

This invention is in the general field of computer-assisted methods of designing compounds such as drugs, particularly designing a ligand that binds to or interacts with a target compound.

### BACKGROUND

Computer-based drug design can be used to optimize compound structure; for example, by discovering compounds with improved ability to bind to a biological target. Often a reference compound having a known structure is used as a starting point and as a point of comparison in optimization.

One approach to optimization is “core hopping”, a type of scaffold-hopping in which the reference compound is divided into a central core and side chains. For purposes of the optimization process, different cores may be substituted for the reference core and then the reference core's side chains added to the new core.

One aspect of optimization is to develop stronger binding, which in turn leads to lower dosage requirements to achieve the same physiological effect. This has several desirable implications, including lower cost and decreased chance of toxic side effects.

Optimization may also remove undesirable molecular properties, such as those affecting absorption, transport and metabolism.

Optimization may avoid regulatory or patent hurdles to clinical development.

One approach to core hopping is described in [Lauri, G. and Bartlett, P. A., “Caveat: A program to facilitate the design of organic molecules”, Journal of Computer-Aided Molecular Design; 1994, 8, 51-66].

### SUMMARY

Introduction

There are two independent aspects of the invention. One is a method for the use of linkers in core hopping generally and the other is a specific method for core hopping. The two aspects complement each other and may be used together, but they may be used independently as well. For example, other methods of core hopping may be augmented by the disclosed method for the use of linkers, and the specifically disclosed core-hopping method may, but need not, be used with linkers.

In core hopping in general, an optimized compound is derived from a reference compound by replacing its core, or central portion, with a new core. Criteria for accepting a candidate replacement core include the candidate replacement core's ability to connect to the side chains, defined as the peripheral molecular fragments attached to the core of the reference compound, in a chemically reasonable geometry that closely approximates the geometry which the side chains exhibited in the reference compound.

Our specifically disclosed core-hopping protocol uses a new method to identify bonds attached to the candidate replacement core that can align well with the bonds connecting the core of the reference compound to its side chains, particularly in the typical situation in which a candidate replacement core possesses more potential attachment bonds than there are side chains on the reference compound. In this situation, the subset or subsets of attachment bonds associated with the candidate replacement core that align well with the bonds connecting the reference compound's core to its side chains are also discovered by the disclosed method.

Our specifically disclosed use of linkers provides a method by which the replacement core that substitutes for the core of the reference compound is extended by insertion of linker groups (for example, methylene groups) into its attachment bonds, if this extension improves the achievable alignment of the attachment bonds with those of the reference compound over the alignment that could be achieved without the use of linkers. The user specifies the maximum number of linker groups permitted for extension of each potential attachment bond and this number of linker groups is added to each potential attachment bond as the first step in the method. Starting from this single prepared extended candidate replacement core, the method we describe discovers the number of linkers (including the possibility of none) required in each side-chain attachment bond in order to match the side-chain geometry exhibited by the reference compound when its core is replaced by the new replacement core, including the discovered linkers. Though this method works with our specifically disclosed core-hopping method, it may also be used with other core-hopping methods.

We describe each aspect of the invention separately, first describing the use of linkers and then describing the specific core-hopping method, which may be used with or without linkers.

Use of Linkers

We have discovered a computer-aided method of automatic addition of linker groups between the substitute core and the side chains when needed to optimize side-chain positioning in core-hopping protocols. With the addition of linkers, some substitute cores which otherwise would be too small can serve as good replacements for the reference core. The invention thus broadens the universe of candidate replacement cores that can be successfully swapped for the core of a specific reference compound, thus enhancing the ability to discover an improved compound.

Thus one aspect of the invention, stated generally, features a computer-aided method of designing a final compound based at least in part on overlap with a reference compound. The final compound includes a protocore and linkers. The method uses data for a reference compound in a specified chemically reasonable configuration. A set of attachment bonds is specified in the reference compound. These separate the reference compound into a core region and side chains. Each attachment bond is a bond between a base atom in the core region and a tip atom on a side chain. The method compares the reference compound data with data for a protocore compound, in which candidate attachment bonds are specified that separate the protocore compound into a core region and peripheral atoms or molecular fragments. Each attachment bond of the protocore compound connects a base atom in the core region of the protocore compound to a tip atom that is either a peripheral atom or part of a peripheral molecular fragment. The method also uses data for linker compounds, where each linker compound includes two attachment bonds, each connecting a base atom in the central linker portion to a tip atom that is either a peripheral atom or part of a peripheral molecular fragment. Data representing an augmented protocore compound is derived. The augmented protocore compound includes at least one linker inserted into at least one attachment bond of the protocore compound, thus creating additional potential attachment bonds within the augmented protocore compound. Data for the reference compound and the augmented protocore compound are compared to determine alignments between the attachment bonds of the augmented protocore compound and the attachment bonds of the reference compound when the augmented protocore compound is in a chemically reasonable conformation. These alignments are evaluated and those that do not fulfill predetermined criteria are discarded. Each alignment of an augmented protocore compound that is not discarded is used to derive a final protocore compound by a process that includes removing linkers that were not used in the alignment and retaining a record of the attachment bonds selected in the alignment.

Preferably, the evaluation of the alignments of an augmented protocore compound with the reference compound includes the use of data from a binding partner of the reference compound, in order to ensure that alignments are rejected that cannot interact well with the binding partner.

The above steps describe the linker-addition method in its more general form. Preferably, the invention also includes generating optimized compounds by attaching the side chains of the reference compound to the corresponding attachment bonds of the final protocore compound in a chemically reasonable configuration. Optimized compound data is compared with reference compound data. Data for a binding partner of the reference compound may also be included in this process. Finally, based on this data comparison for optimized compounds derived from many augmented protocores, the method selects and/or ranks one or more optimized compounds.

Preferably, when alignments of attachment bonds are determined, alignments are excluded in which two or more selected attachment bonds on the augmented protocore compound are in the same branch.

Preferably, in the process of creating augmented protocore compounds, protocore compounds are ignored that do not have at least as many attachment bonds as the reference compound possesses. This ensures that all alignments generated will provide a matching attachment bond on the augmented protocore compound for every attachment bond on the reference compound.

The process of generating the augmented protocore compound may include: cleaving an attachment bond of the protocore compound; cleaving both attachment bonds of the linker compound, discarding the linker tip atoms; connecting the base atom of the linker compound's first cleaved attachment bond to the base atom of the protocore compound's cleaved attachment bond in a chemically reasonable configuration, thus creating an attachment bond whose base atom remains the base atom of the protocore compound's cleaved attachment bond and whose tip atom is the base atom of the linker's first cleaved attachment bond; connecting the base atom of the linker's second attachment bond to the tip atom of the protocore compound's cleaved attachment bond in a chemically reasonable configuration, thus creating an additional attachment bond whose base atom is the base atom of the linker's second cleaved attachment bond and whose tip atom is the tip atom of the protocore compound's cleaved attachment bond. Optionally, additional attachment bonds are defined whose base atoms are linker atoms and whose tip atoms are peripheral atoms or atoms belonging to peripheral molecular fragments of the linker compound, thus creating a further augmented protocore compound. The above process may be repeated for other attachment bonds of the original protocore compound, thus creating a still further augmented protocore compound.

Preferably, additional linkers may be inserted into attachment bonds created by the above process, thereby creating a further augmented protocore.

The process of creating a final protocore compound from an aligned protocore compound consists of removing linkers that do not lie between the core of the original protocore compound and the selected attachment bonds. This process is carried out for each such linker by breaking the bonds to it that were made when the linker was added to an attachment bond in the process of creating the augmented protocore compound. After breaking these two bonds, the fragment thus created containing the linker is discarded and then a bond is formed between the two remaining fragments in a chemically reasonable configuration.

Possible linkers include, but are not limited to: methylene, ethylene, o, m, p-phenylene, ethers, carbonyls, amines and amides.

Preferably, the determination of alignments between the attachment bonds of the augmented protocore compound and those of the reference compound proceeds in two steps. In the first step, pairs of base atoms are selected that belong to pairs of attachment bonds, one attachment bond of each pair belonging to the reference compound and the other belonging to the augmented protocore compound, and this pairing of base atoms is evaluated. If this pairing of base-atom pairs does not meet predetermined alignment criteria, it is discarded; otherwise, the second step is carried out. In the second step, for each base atom selected in the augmented protocore, a unique tip atom is selected from among the base atom's associated attachment bonds, thus completing a selection of attachment bonds in the augmented protocore compound that align to the attachment bonds of the reference compound.

Given a set of pairs of base atoms from of the first step of the alignment process just described, one way of evaluating the pairing comprises, in part, a rigid-body superposition of the corresponding atom pairs determined in that stage.

Another method of evaluating the base-atom pairing is application of energetic minimization with constraints applied between the base-atom pairs to attempt to superimpose them.

Preferably, this energetic minimization will be carried out in a binding site of a binding partner for the reference compound, in order to penalize alignments of the augmented protocore that interact poorly with this binding partner.

Preferably, the binding partner used in this energetic minimization is a biological target.

However the selection of corresponding attachment bonds between the reference compound and the augmented protocore compound is carried out and evaluated, the selection and/or evaluation may include detection and enforcement of at least one constraint on the augmented protocore compound defined with respect to a binding partner of the reference compound. Poses of the augmented protocore compound that cannot meet a predetermined number of constraints are rejected and an augmented protocore compound none of whose poses can meet the predetermined number of constraints is rejected.

Preferably, the constraint or constraints are hydrogen-bonding or hydrophobic constraints.

Possibly, the constraints are derived from constraints fulfilled by the core of the reference compound in its configuration when docked with a binding partner.

Preferably, when the alignment and/or evaluation of alignment bonds between the reference compound and the augmented protocore compound is carried out using a two-step process, as described above, in which the first step is the selection of pairs of corresponding base atoms, one base atom in each pair belonging to the augmented protocore compound and the other belonging to the reference compound, the evaluation consists in part of determining the interatomic displacement of the base atoms of each pair. If the worst such displacement for any pair, or some collective measure of displacement, such as root-mean-square of the displacements for all the pairs, is greater than a predetermined maximum, the selection is rejected and another selection is evaluated; otherwise, the selection is accepted and the second stage, in which a tip atom is selected, is carried out.

Preferably, when the selection and/or evaluation of alignment bonds between the reference compound and the augmented protocore compound is carried out using this two-step process, some base atoms selected on the augmented protocore compound may have multiple tip atoms (that is, multiple attachment bonds) associated with them. In this situation, the further process of selecting a unique tip atom for each such already selected base atom includes the evaluation of one of two alternative scores. One alternative score is the displacement in space of the tip atom of the attachment bond associated with the base atom of the reference compound from that of the proposed tip atom associated with the base atom of the augmented protocore compound, where, for the purposes of this comparison only, the distance computation is done with these tip atoms at a fixed, predetermined distance from their base atoms along the corresponding attachment bonds. A fixed distance is used to remove artifacts due to varying chemical bond lengths. A smaller displacement in space corresponds to a better score. The other alternative score is the degree of alignment between the vector from base atom to tip atom of the attachment bond belonging to the reference compound and the corresponding vector belonging to the augmented protocore compound. This is conveniently measured by the cosine of the angle between the vectors, and here a greater value corresponds to a better score. The overall score of a selection of several pairs of attachment bonds can comprise either the worst such score or some collective measure, such as the average or root-mean-square, of the scores of the aligned pairs. If the overall score fails to fulfill a predetermined criterion, the current attachment-bond alignment is rejected. If the overall score does fulfill the predetermined criterion, it is accepted.

Preferably, when optimized compounds are generated, comparison of an optimized compound with the reference compound includes evaluation of whether the side-chain atoms of the optimized compound can align well with the side-chain atoms of the reference compound.

Preferably, when optimized compounds are generated, comparison of an optimized compound with a binding partner of the reference compound includes evaluation of whether the optimized compound is likely to bind well to the binding partner, comprising evaluation of a docking score, such as the one described in [Friesner, R. A., et al., “Glide: A New Approach for Rapid, Accurate Docking and Scoring. 1. Method and Assessment of Docking Accuracy”, J. Med. Chem., 2004, 47, 1739-1749; Halgren, T. A., et al., “Glide: A New Approach for Rapid, Accurate Docking and Scoring. 2. Enrichment Factors in Database Screening”, J. Med. Chem., 2004, 47, 1750-1759].

Possibly, when optimized compounds are generated, comparison of an optimized compound with a binding partner of the reference compound includes detection and enforcement of at least one constraint on the optimized compound defined with respect to the reference compound. If a predetermined number of constraints cannot be fulfilled by the pose of the optimized compound, that pose is rejected. If the predetermined number of constraints cannot be fulfilled by any pose of the optimized compound, that optimized compound is rejected.

Preferably, constraints used in comparing an optimized compound with a binding partner of the reference compound are conserved hydrogen-bonding or hydrophobic interactions.

Possibly, constraints used in comparing an optimized compound with a binding partner of the reference compound are derived from the reference compound in its configuration when docked with the binding partner.

Possibly, when comparing reference compound data with data for augmented protocore compounds, final protocore compounds, or optimized compounds, multiple conformations and spatial positions and orientations for the augmented protocore compound are sampled, distances between the base atoms of the reference compound and the base atoms of the protocore compound are computed, and a number of corresponding base atom pairs are selected at least in part in order of spatial proximity of the pairs of atoms, each pair comprising one base atom on the reference compound and one base atom on the protocore compound.

Possibly, data for the reference compound is provided in multiple chemically reasonable configurations, and the method is repeated for each configuration.

Improved Core Hopping, Regardless of Whether Linkers are Used.

Another aspect of the invention permits, but does not require, the use of linkers as described above. As with the first aspect of the invention, the second aspect includes the same steps of providing data for the reference compound in a specified configuration and for a protocore compound, both of which include attachment bonds that divide the reference compound into a core and side chains and the protocore compound into a core and peripheral atoms or peripheral molecular fragments. These data are compared to determine whether the attachment bonds of the protocore compound align with a set of attachment bonds of the reference compound by a method that includes: i) sampling the chemically reasonable conformations of the protocore compound, ii) placing the chemically reasonable conformations of the protocore compound in a variety of positions and orientations in space with regard to the reference compound, iii) deriving a list of atom pairs to use in aligning the protocore compound with the reference compound, based on spatial proximity of atoms belonging to the attachment bonds of the reference compound to atoms belonging to the attachment bonds of the protocore compound in its current conformation, spatial position and orientation; iv) moving the protocore compound in space so as to optimize the alignment of the atom pairs, v) evaluating, for the optimized alignment, a measure of alignment between the attachment bonds on the reference compound and the corresponding attachment bonds on the protocore compound. We derive one or more final protocore compounds based at least in part on this evaluation, the derivation comprising selection of a set of attachment bonds on the protocore compound that align with corresponding attachment bonds on the reference compound. In the steps described above, data from a binding partner of the reference compound may be used to ensure that the aligned protocore compound interacts favorably with the binding partner.

The above steps describe the core-hopping aspect of the invention in its most general form. Preferably, an augmented protocore compound derived from linker addition into the attachment bonds of the protocore compound is used in steps c) and d) above in place of the protocore compound to generate final protocore compounds.

Preferably, the invention also includes: attaching tip atoms of each of the reference compound side chains to base atoms of corresponding attachment bonds of the final protocore compounds in a chemically reasonable configuration, thereby generating optimized compounds; comparing data for the optimized compounds with the reference compound and optionally with data for a binding partner of the reference compound, and selecting one or more optimized compounds based at least in part on this data comparison.

Preferably, the atom pairs derived the general method consist of pairs of base atoms of attachment bonds, one base atom in each pair being the base atom of an attachment bond in the reference compound and the other base atom in each pair being the base atom of an attachment bond in the protocore compound.

Also preferably, derivation of the pairs of base atoms just described includes the following steps: a) for each base atom on the reference compound and each base atom on the protocore compound, initialize a counter with the number of attachment bonds it is associated with; b) initialize an empty list of base-atom pairs that will be filled by the procedure described below with corresponding pairs of base atoms, each pair consisting of one base atom from the reference compound and one base atom from the protocore compound; c)compute the distance between each base atom on the reference compound and each base atom of the protocore compound, and place the distances in a list, maintaining a record of which base atom from the reference compound and which base atom from the protocore compound each distance is associated with; d) sort the list of distances, maintaining the record of which base atom from the reference compound and which base atom from the protocore compound each distance is associated with; e) evaluate each member of the list of distances in order from smaller to larger distances, and i) if the counter is zero for the base atom belonging to the reference compound that is associated with this distance, skip this distance; ii) if the counter is zero for the base atom belonging to the protocore compound that is associated with this distance, skip this distance; iii) otherwise, add the two base atoms associated with this distance as a new pair on the list of base-atom pairs, and decrement the counters of both the base atoms by one; terminate the process when the number of pairs in the list of base-atom pairs is equal to the smaller of the number of attachment bonds on the reference compound and the number of attachment bonds on the protocore compound; or, if the numbers are equal, that number.

Preferably, in carrying out the basic method, prior to the comparison of reference compounds to protocore compounds, protocore compounds that possess fewer attachment bonds than the number on the reference compound are rejected. This ensures that when alignments are performed, every attachment bond on the reference compound will be matched with an attachment bond on the protocore compound.

Possibly, the step in the basic method in which the protocore compound is moved in space to align optimally with the reference compound comprises performing a rigid-body motion of the protocore compound so as to attempt to superimpose the selected pairs of corresponding atoms.

Possibly, the step in the basic method in which the protocore compound is moved in space to align optimally with the reference compound comprises the use of energetic minimization with the constraints applied between the pairs of corresponding atoms used in the alignment, in order to attempt to superimpose these atom pairs.

Possibly, the specified configuration of the reference compound may be its configuration when docked with a binding partner for the reference compound and the energetic minimization may be carried out in a binding site of the binding partner.

Preferably, such a binding partner of the reference compound is a biological target.

Possibly, when the energetic minimization is carried out in a binding site of a binding target of the reference compound, the minimization process further comprises detection and enforcement of at least one constraint on the protocore compound defined with respect to a binding partner of the reference compound. Poses of the protocore compound that cannot fulfill a predetermined number of constraints are rejected and a protocore compound none of whose poses can meet the predetermined number constraints is rejected.

Preferably, the constraint or constraints are hydrogen-bonding or hydrophobic constraints.

Possibly, the constraints are derived from constraints fulfilled by the core of the reference compound in its configuration when docked with a binding partner.

Preferably, when the atom pairs whose alignment is optimized by moving the protocore compound arc pairs of base atoms, one base atom from each pair belonging to the reference compound and the other belonging to the protocore compound, the evaluation of the alignment includes a determination of the residual atomic displacement of the atom pairs, and an overall score is defined, comprising either the worst such displacement for any pair or some collective measure of displacement, such as an average or root-mean-square of the displacements for all the pairs. If this score is greater than some predetermined value, the current base-atom pairing is rejected and a new base-atom alignment is sampled. If the score is less than the predetermined maximum, the current base-atom pairing is accepted and, for each selected base atom in the protocore, its best-matching tip atom is selected.

Preferably, when a selection of base atom pairs has been selected, as just described, the selection of which tip atom to select for each selected base atom of the protocore compound includes evaluating one of two alternative scores. One alternative score is the displacement in space of the tip atom of the attachment bond associated with the base atom of the reference compound from that of the proposed tip atom associated with the base atom of the protocore compound, where, for the purposes of this comparison only, the distance computation is done with these tip atoms at a fixed, predetermined distance from their base atoms along the corresponding attachment bonds. A fixed distance is used to remove artifacts due to varying chemical bond lengths. A smaller displacement in space corresponds to a better score. The other alternative score is the degree of alignment between the vector from base atom to tip atom of the attachment bond belonging to the reference compound and the corresponding proposed vector belonging to the augmented protocore compound. This is conveniently measured by the cosine of the angle between the vectors, and here a greater value corresponds to a better score. The overall score of a selection of several pairs of attachment bonds can comprise either the worst such score or some collective measure, such as the average or root-mean-square, of the scores of the best-aligned pairs. Then, if this overall score does not fulfill some predetermined criterion, the overall alignment is rejected and a new base-atom selection is sampled. If the overall score fails to fulfill the predetermined criterion, the overall alignment is rejected and a different base-pair selection is evaluated. If the overall score does fulfill the predetermined criterion, it is tentatively accepted; however, if data from a binding partner of the reference compound is being used in the alignment and evaluation process, the current alignment may still be rejected if it fails to interact in the desired way with the binding partner. If, however, it is not rejected on these grounds, the current alignment is used to create a final protocore compound, as described in step d) of the basic method.

Preferably, when optimized compounds are generated, comparison of an optimized compound with the reference compound includes evaluation of whether the side-chain atoms of the optimized compound can align well with the side-chain atoms of the reference compound.

Preferably, when optimized compounds are generated, comparison of an optimized compound with a binding partner of the reference compound includes evaluation of whether the optimized compound is likely to bind well to the binding partner, comprising evaluation of a docking score, such as the one described in [Friesner, R. A., et al and Halgren, T. A., et al., cited earlier].

Possibly, when optimized compounds are generated, comparison of an optimized compound with a binding partner of the reference compound includes detection and enforcement of at least one constraint on the optimized compound defined with respect to the reference compound. If a predetermined number of constraints cannot be fulfilled by the pose of the optimized compound, that pose is rejected. If the predetermined number of constraints cannot be fulfilled by any pose of the optimized compound, that optimized compound is rejected.

Preferably, constraints used in comparing an optimized compound with a binding partner of the reference compound are conserved hydrogen-bonding or hydrophobic interactions.

Possibly, constraints used in comparing an optimized compound with a binding partner of the reference compound are derived from the reference compound in its configuration when docked with the binding partner.

Preferably, when the core-hopping method is carried out using an augmented protocore compound derived by addition of linkers into the attachment bonds of a protocore compound, and the atom pairs used for alignment in the basic method consist of pairs of base atoms of attachment bonds, one base atom in each pair being the base atom of an attachment bond in the reference compound and the other base atom in each pair being the base atom of an attachment bond in the augmented protocore compound, the derivation of the pairs of base atoms includes the following steps: a) initialize variables as follows: i) for each base atom on the reference compound and each root base atom on the augmented protocore compound, initialize a counter with the number of attachment bonds it is associated with, and ii) for each branch on the augmented protocore compound, initialize a Boolean variable to False, indicating that the branch has not yet been used; b) initialize an empty list of base-atom pairs that will be filled by the procedure described below with corresponding pairs of base atoms, each said pair consisting of one base atom from the reference compound and one base atom from the augmented protocore compound; c) compute the distance between each base atom on the reference compound and each base atom of the augmented protocore compound, and place said distances in a list, maintaining a record of which base atom from the reference compound and which base atom from the augmented protocore compound each said distance is associated with; d) sort said list of distances, maintaining said record of which base atom from the reference compound and which base atom from the augmented protocore compound each said distance is associated with; e) evaluate each member of said list of distances in order from smaller to larger distances, and i) if the counter is zero for the base atom belonging to the reference compound that is associated with this distance, skip this distance; ii) if the counter is zero for the root base atom belonging to the augmented protocore compound that is associated with this distance, skip this distance; iii) otherwise, if the augmented protocore compound's base atom is not a root base atom and its branch's Boolean variable is True, skip this distance; iv) otherwise, add the two base atoms associated with this distance as a new pair on the list of base-atom pairs, decrement the counters of both said base atoms by one, and, if the base atom belonging to the augmented protocore is not a root base atom, set its Boolean variable to True; f) terminate the process when the number of pairs in the list of base-atom pairs is equal to the smaller of the number of attachment bonds on the reference compound and the number of attachment bonds on the augmented protocore compound; or, if said numbers are equal, that number.

Possibly, data for the reference compound is provided in multiple chemically reasonable configurations, and the method is repeated for each configuration.

### DESCRIPTION OF DRAWINGS

In FIGS. 1a through 1f; hydrogens are implicit, except where otherwise mentioned. FIGS. 1a through 1e, taken in order, illustrate the successive stages of the core-hopping process described below when linkers are in use.

FIG. 1a shows a reference compound.

FIG. 1b shows a protocore compound for use in optimizing the structure of FIG. 1a.

FIG. 1c shows the augmented protocore compound created by insertion of two methylene linkers into each of the protocore compound's attachment bonds, where these attachment bonds are taken as bonds to hydrogen.

FIG. 1d shows the final protocore compound derived from the augmented protocore compound of FIG. 1c by deletion of all linkers except those that best match the attachment bonds of the reference compound. Of the six methylene linkers present in the augmented protocore compound, only four were selected for use in the final protocore compound. Only the hydrogens associated with the selected attachment bonds are shown.

FIG. 1e shows the optimized compound created by adding the side chains of the reference compound to the selected attachment bonds of the final protocore compound.

FIG. 1f shows the optimized compound superimposed upon the reference compound.

FIG. 2 illustrates the augmented protocore compound of FIG. 1c, showing explicit hydrogens. For the set of linkers added into one of the attachment bonds of FIG. 1c, the new set of attachment bonds has been shown explicitly, and the system of labeling described below is shown. The atoms labeled with a single component (that is, whose labels have no decimal points) are root base atoms. The remaining atoms have multiple components in their labels (that is, at least one decimal points). All atoms whose labels share the same first two components (that is, to the same two numbers on either side of the first decimal point) are in the same branch. This is shown explicitly for only one branch, but the same pertains to the branches emanating from all the root base atoms.

FIG. 3 shows a compound with multiple side chains attached to the same base atom.

FIGS. 4a through 4f depict three-dimensional data obtained from the actual operation of the algorithm. They show core regions in the same frame of reference, defined by the surrounding rectangles, and are projections of three-dimensional views. FIGS. 4a through 4f are analogous to FIGS. 1a through 1f.

FIG. 4a shows the stricture of a triazine modulator of estrogen-receptor activity used as the reference compound in a core-hopping study. Only polar hydrogens are shown. The bonds shown with thick lines are the attachment bonds selected by the user.

FIG. 4b shows an indazole protocore compound. All hydrogens are shown. The bonds to these hydrogens were used as the attachment bonds.

FIG. 4c shows the augmented protocore compound derived from the protocore compound of FIG. 4b by addition of two methylene linkers inserted into each attachment bond. The carbon atoms of the linkers are shown as circles. All hydrogens are shown as unlabeled terminal atoms.

FIG. 4d shows the final protocore compound derived from the augmented protocore compound of FIG. 4c. Only the linkers required for optimal alignment with the reference compound of FIG. 4a have been retained. The selected attachment bonds are shown with heavy lines. The carbon atoms of the linkers are shown as circles. The only hydrogens displayed are the tip atoms of the selected attachment bonds.

FIG. 4e shows the optimized compound obtained by adding side chains from the reference compound of FIG. 4a to the final protocore compound shown in FIG. 4d. The side-chain degrees of freedom have been optimized so as to align the side chains as well as possible with their positions in the reference compound. The selected attachment bonds are displayed with heavy lines and the carbon atoms of the methylene linkers are shown as circles. Polar hydrogens are shown.

FIG. 4f shows the reference compound of FIG. 4a and the optimized compound of FIG. 4e superimposed in a surface representation of the 1NDE binding pocket. The attachment bonds of the optimized compound are displayed with heavy lines and the carbon atoms of the methylene linkers are shown as circles. Polar hydrogens are shown. Atom element labels may be inferred from FIGS. 4a and 4e.

Like reference symbols in the various drawings indicate like elements.

### DETAILED DESCRIPTION

Before providing the detailed description, it is useful to review some terminology

### Terminology

Reference compound: A compound with observed or inferred biological activity, usually but not always against a known biological target. The reference compound is used as the basis for subsequent lead optimization. The reference compound is assumed to be in one or more fixed conformations and possibly in one or more fixed poses.

Biological target: A compound that interacts with the reference compound. Typically a biological target is a large naturally occurring compound that mediates one or more biochemical processes in a living organism and whose function can be modulated by interaction with other compounds, either naturally occurring or man-made. In drug discovery, a biological target is usually a receptor or an enzyme.

Pose: A defined conformation of a compound, together with its position and orientation with respect to a biological target.

Scaffold hopping: The search for compounds with similar bioactivity to a reference compound but with a different molecular framework.

Core hopping: A form of scaffold hopping where the effort is focused on finding a replacement for the core of a reference compound.

Core: The central part of a compound that is replaced during a core-hopping exercise, or the new central part that replaces it.

Side chain: A connected group of atoms attached to the periphery of a core. Usually, a core bears several side chains.

Attachment bond: A chemical bond that connects the core or central portion of a compound with a side chain or with a peripheral atom or peripheral molecular fragment. When an attachment bond is referred to as a vector, the implied directionality is always from base to tip atom.

Base atom: The atom of an attachment bond that is part of the central portion of a compound; for example, the core of a reference compound or protocore compound, the core-containing portion of an augmented protocore compound, or the linker portion of a linker compound.

Tip atom: The atom of an attachment bond that is part of the peripheral portion of a compound; for example, the side chain of a reference compound.

Protocore compound: A compound whose core is a candidate for replacing the core of the reference compound. A protocore compound may have many attachment bonds, which are candidates for alignment with the attachment bonds of the reference compound. When linkers are in use, we sometimes refer to the protocore compound as the “original protocore compound”, to distinguish it explicitly from the augmented protocore compound created by the addition of linkers. Though, for convenience, we refer to a protocore compound as a chemical compound throughout, a protocore compound may also be specified as a central molecular fragment (core), lacking peripheral atoms or peripheral fragments. If so, its attachment bonds are to be understood as vectors pointing in the directions where the peripheral bonds of a true chemical compound possessing this central fragment would point, and the associated tip atoms are to be understood as points in space located along those vectors.

Augmented protocore compound: A compound derived from a protocore compound by addition of linkers into its attachment bonds. This procedure creates multiple attachment bonds for each attachment bond in the protocore compound, some lying out along the chain or tree of linkers added. When linkers are in use, an augmented protocore compound, rather than an original protocore compound, is used in core hopping. Though, for convenience, we refer to an augmented protocore compound as a chemical compound throughout, an augmented protocore compound may also be specified as a central molecular fragment, lacking peripheral atoms or peripheral fragments. If so, its attachment bonds are to be understood as vectors pointing in the directions where the peripheral bonds of a true chemical compound possessing this central fragment would point, and the associated tip atoms are to be understood as points in space located along those vectors.

Branch: In an augmented protocore compound, the set of linker atoms and associated attachment bonds resulting from insertion of a linker or linkers into a single attachment bond of the original.

Root base atom: In a branch of an augmented protocore compound, the base atom of the attachment bond on the original protocore compound that the linkers were inserted into to form the branch.

Final protocore compound: A compound derived from an original protocore compound or an augmented protocore compound by selection of a subset of its attachment bonds that align well with corresponding attachment bonds on a reference compound. If derived from an augmented protocore compound, only those linkers that lie between each selected attachment bond and the core of the original protocore compound are retained in the final protocore compound; the other linkers are deleted. A single protocore compound or augmented protocore compound can give rise to multiple final protocore compounds distinguished by possessing differing sets of selected attachment bonds or differing correspondences of their selected attachment bonds with those of the reference compound. The final protocore compound, minus the tip atoms of the selected attachment bonds, is the entity that replaces the core of the reference compound.

Optimized compound: A compound derived from a final protocore compound by attaching the side chains of the reference compound to the final protocore compound's selected attachment bonds. Each selected attachment bond in the final protocore compound receives the side chain that is attached to the corresponding attachment bond in the reference compound. Each final protocore compound gives rise to a single optimized compound, which may then be accepted or rejected depending on how well it aligns with the reference compound and possibly how well it is predicted to bind to a binding partner of the reference compound, typically a biological target. The optimized compound is the full molecule that is a candidate for replacement of the reference compound.

Linker: An atom or connected group of atoms added between a core and a side chain. In core hopping with linkers as disclosed here, the linkers are added into the attachment bonds of the protocore compounds to form augmented protocore compounds.

Linker compound: A compound whose central portion can be used as a linker. A linker compound always has exactly two attachment bonds separating the linker portion from peripheral atoms. Though, for convenience, we refer to a linker compound as a chemical compound throughout, a linker compound may also be specified as a central molecular fragment (linker), lacking peripheral atoms or peripheral fragments. If so, its attachment bonds are to be understood as vectors pointing in the directions where the peripheral bonds of a true chemical compound possessing this central fragment would point, and the associated tip atoms are to be understood as points in space located along those vectors.

### Core Hopping as Used in the Invention

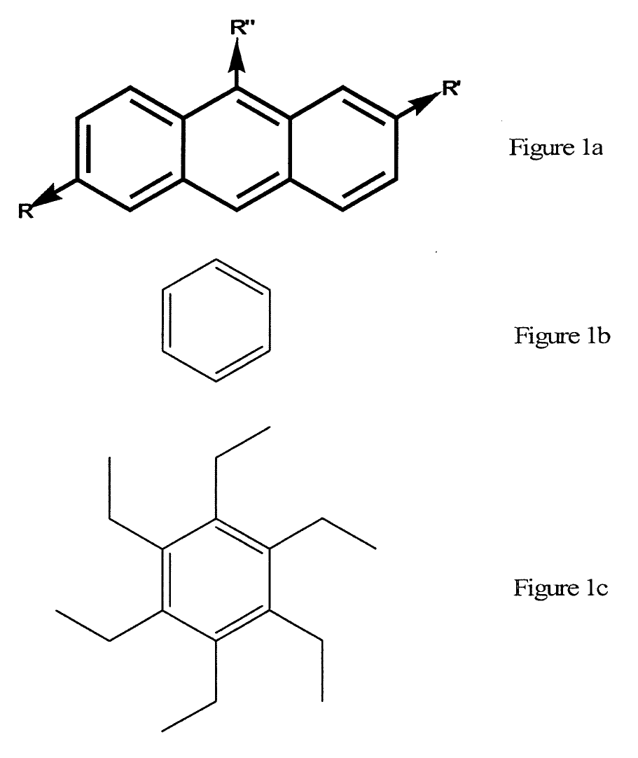

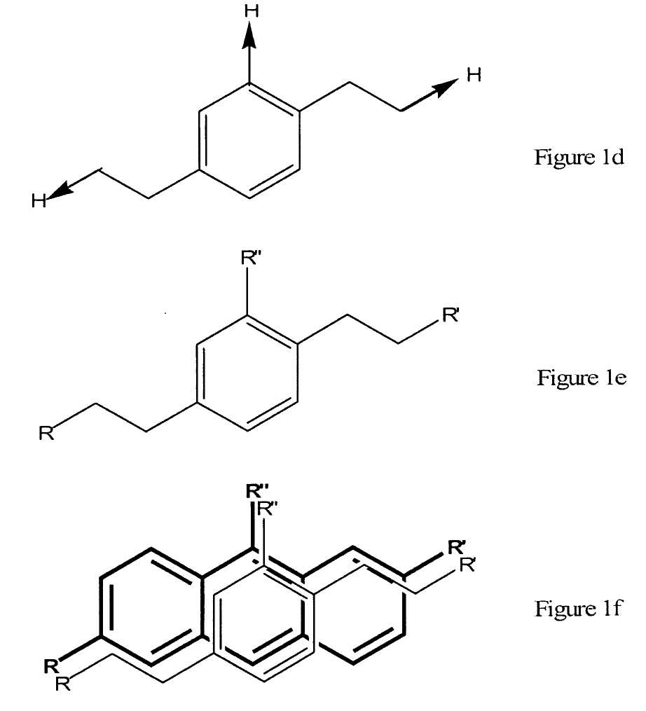

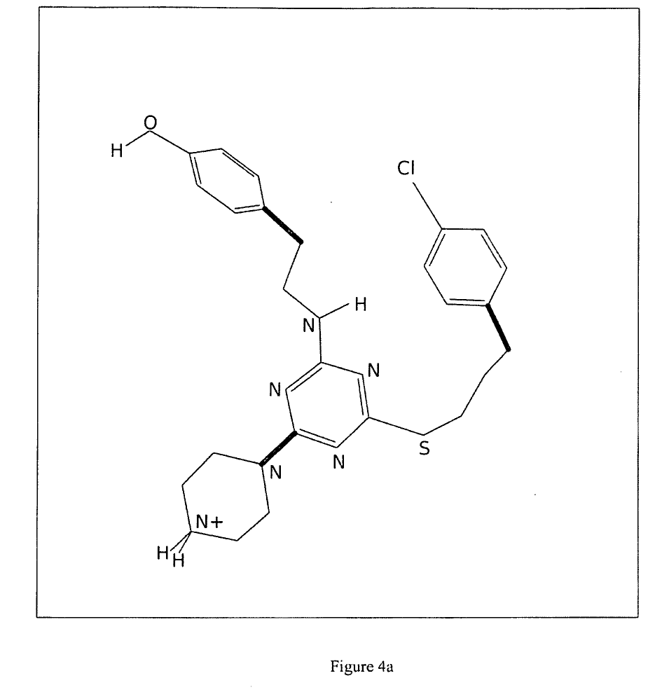

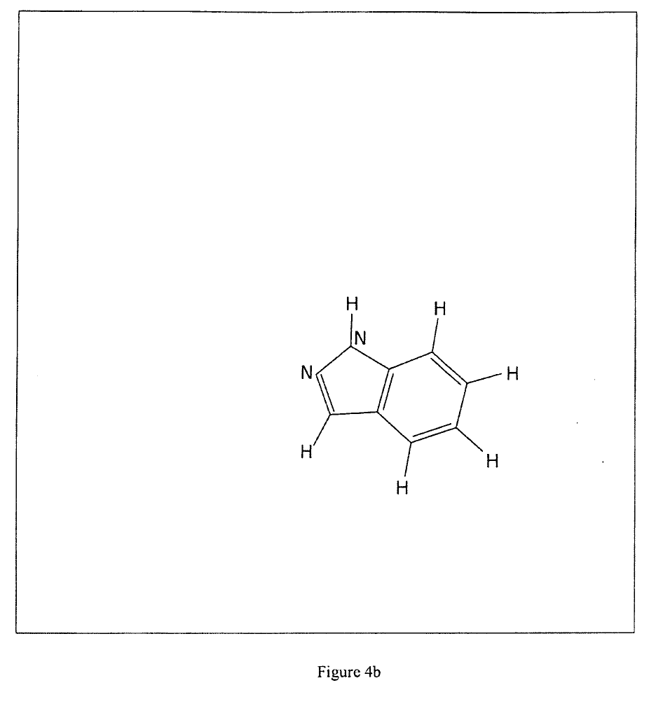

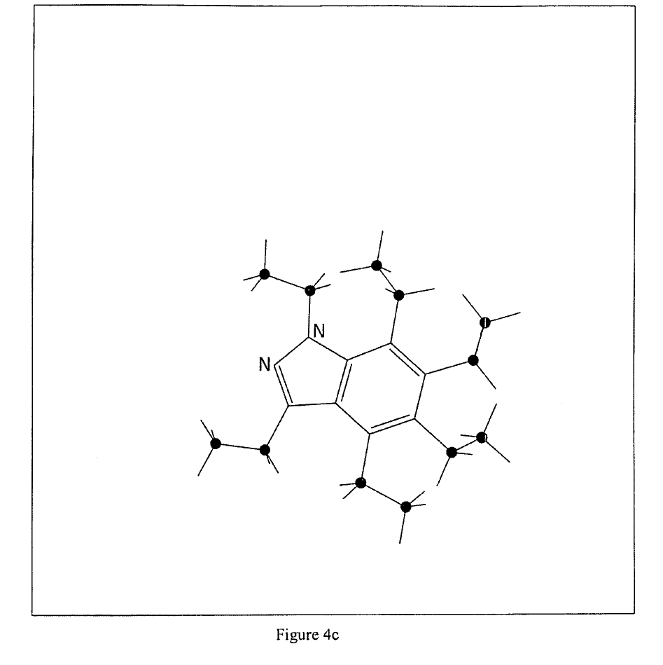

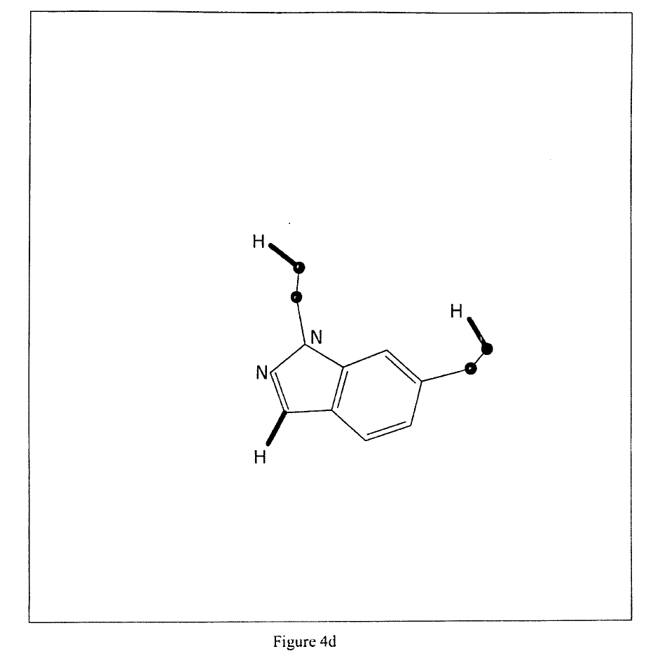

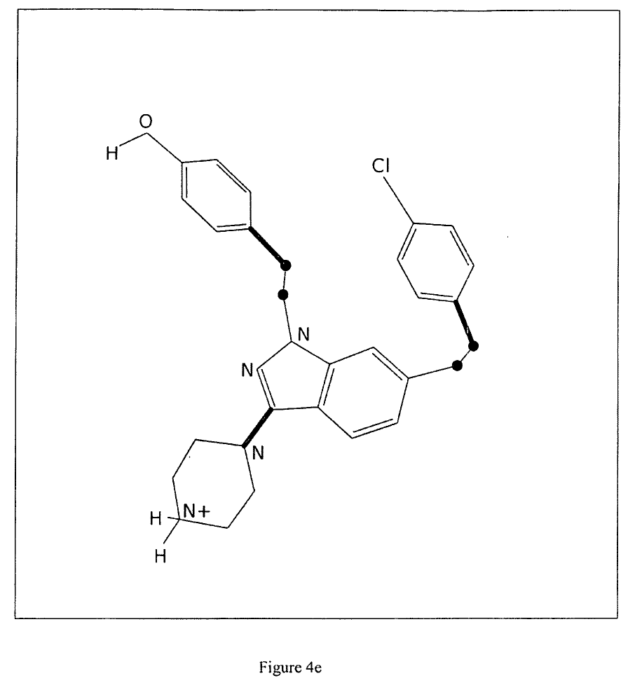

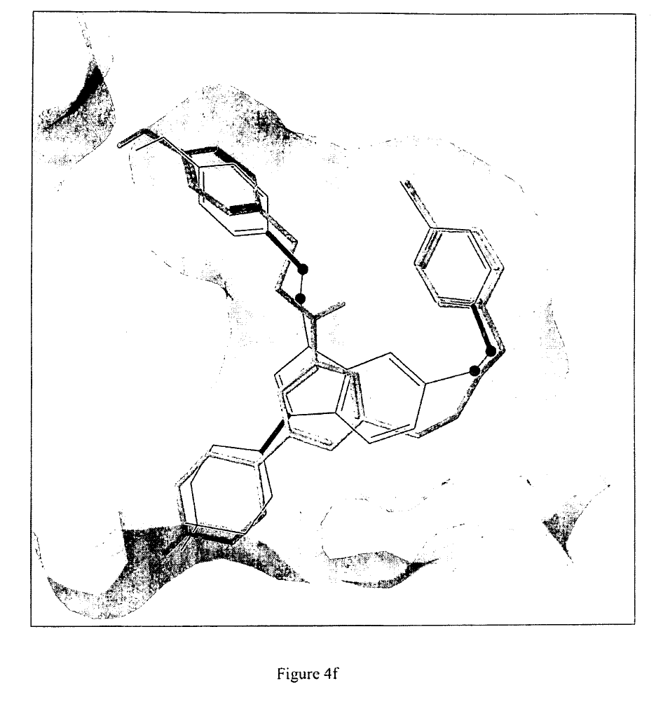

The form of core-hopping we consider here holds the reference compound fixed in its active conformation. If its active conformation is not known, and it is desired to sample its degrees of conformational freedom, then the procedure described here may be carried out separately for the chemically reasonable conformations of the reference compound. The user specifies attachment bonds within the reference compound. These define the core and the side chains, as shown in FIGS. 1a and 4a. The reference compound's core need not be a rigid or nearly rigid entity; it is merely the central region whose replacement is desired. In fact, one use of core hopping is to replace a flexible core with a more rigid core derived from a protocore compound. In this situation, the attachment bonds specified in the reference compound by the user may define a rather flexible core. Since the reference compound is held fixed, its attachment bonds form a fixed array of vectors in space. We then attempt to find final protocore compounds with sets of attachment bonds that can be well aligned, geometrically, with the attachment bonds specified in the reference compound. The protocore compounds may come from a pre-formed library of structures or may be provided in some other manner.

The protocore compounds are compounds whose central portions the user desires to consider as candidates to replace the core of the reference compound. By default, bonds connecting this central portion to hydrogen atoms are taken as the attachment bonds; however, the user may instead designate specific bonds to be so taken. The set of attachment bonds defines the core and the peripheral portions of a protocore compound. The effort, then, is to find some set of attachment bonds in the protocore compound or in the derived augmented protocore compound that aligns well with the attachment bonds of the reference compound. This set of selected attachment bonds defines the final protocore compound.

We first describe rules that a set of attachment bonds must meet in order to divide a compound into a central portion and peripheral atoms or peripheral molecular fragments. The central portion is termed a core if the starting compound is a reference compound or a protocore compound, or a linker if the starting compound is a linker compound. The peripheral atoms or molecular fragments are called side chains if the compound is a reference compound.

Following this, we describe our core-hopping method, which can be used with or without addition of linkers, and then describe below automatic linker addition, which can be used either in our core-bopping method or in other core-hopping methods.

### Rules for Attachment Bonds

The following rules ensure that a set of attachment bonds divides a compound into a central portion and peripheral atoms or peripheral molecular fragments, such that each attachment bond has a unique peripheral atom or peripheral molecular fragment associated with it:
1. Each attachment bond is a chemical bond with specified base and tip atoms.
2. No attachment bond is in a ring.
3. If any attachment bond were cleaved, the molecular fragment containing its tip atom would not contain the base or tip atom of any other attachment bond.

A modification of these rules is described below for the situation when linkers are in use.

### Protocore Compound Alignment and Selection Method

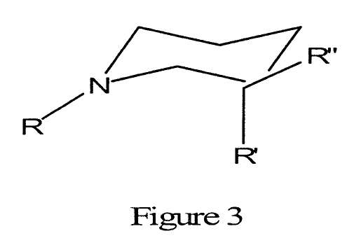

The method described as follows, starting with Step 2, is carried out for each protocore compound.
1. Reference-compound specification. The reference compound is provided in a known conformation and, optionally, a pose based on its conformation when docked to a binding partner, and its attachment bonds are selected. As shown in FIG. 1a, this divides the reference compound into a core region (the aromatic region in FIG. 1a) and the side chains (the R groups in FIG. 1a).
2. Conformational sampling. Though the reference compound is considered rigid, the protocore compound may be flexible, and if so, the following steps are carried out for each chemically reasonable conformation.
3. Spatial sampling. The protocore compound in its current conformation is placed in a large number of positions and orientations in the vicinity of the reference compound. This may be done in a variety of ways; for example a grid may be defined that encloses the reference compound and the centroid of the protocore compound then placed at the various grid positions and oriented in various directions.
4. Base-atom selection. The base atom of each attachment bond in the reference compound is paired with a base atom of the protocore compound using the atom-selection algorithm described in the next section. Usually, there are more base atoms in the protocore compound than there are in the reference compound, and if so, a subset of the protocore compound's base atoms is selected. However, it is also possible that the protocore compound may have fewer base atoms than does the reference compound, or the same number. The number of protocore compound base atoms we select is always the smaller of the number on the protocore compound and the number on the reference compound.
5. Protocore compound alignment. We alter the position of the protocore compound so as to optimize the alignment of its selected base atoms to the corresponding base atoms on the reference compound. This can be done in several ways; for example:
   a. Rigid-body superposition of the protocore compound onto the reference compound, minimizing the root-mean-square interatomic displacement of the paired base atoms;
   b. Energy minimization of the protocore compound with constraints in place so as to minimize distances between paired base atoms;
   c. Energy minimization as in (b), but in the binding pocket of a biological target in which the reference compound is known to bind, thus eliminating alignments inconsistent with protocore compound poses that fit the pocket;
   d. Energy minimization as in (c), requiring the satisfaction of additional constraints, such as hydrogen-bonding or hydrophobic patterns believed to be important for biological activity, thus eliminating protocore compounds and protocore compound alignments that cannot satisfy these constraints.
6. Base-atom acceptance. If the aligned paired base atoms meet a geometric criterion, we proceed to the next step. Otherwise, we proceed to the next spatial sample. Typical criteria are root-mean-square or worst interatomic displacement of paired base atoms.
7. Tip-atom selection. If any of the reference compound's or protocore compound's base atoms serves as the base for more than one possible attachment bond, as in FIG. 3, the best aligned of tip atoms are selected for such base atoms, as described in the next section. Once tip-atom selection is complete, each attachment bond on the reference compound has been paired with a corresponding attachment bond on the protocore compound.
8. Attachment-bond acceptance. If the paired attachment bonds meet a geometric criterion, we proceed to the next stage. Otherwise, we proceed to the next spatial sample. Typical criteria are root-mean-square or worst interatomic displacement of corresponding base and tip atom pairs (where fictitious and equal attachment-bond lengths are used in the computation), or average or worst angular differences between corresponding attachment bonds, considered as vectors pointing from base to tip.
9. Sidechain optimization. The side chains of the reference compound are attached to the corresponding attachment bonds of the protocore compound. The conformations of the side chains are then optimized, using chemically reasonable rotations about bonds, to match the corresponding side chains in the reference compound as well as possible. Optionally, this optimization is carried out in the binding pocket of a biological target, which allows avoidance of clashes with the structure of the biological target. If a good alignment can be obtained, the structure is saved; otherwise, we proceed to the next spatial orientation.
10. Evaluation. A figure of merit is computed that can be used to rank-order the compounds produced by the above procedure. This can be purely geometric, based on criteria such as goodness of alignment of side chains, but if carried out in the binding pocket of a biological target, additional criteria such as fulfillment of desired constraints and a docking score, such as that described by [Friesner, R. A., et al. and Halgren, T. A., et al., cited earlier] can also be included.

The net effect of the above procedure is that a protocore compound might give no good alignments, one good alignment, or multiple good alignments with the reference compound, and the resulting compounds, consisting of the protocore compounds with reference compound's side chains added in various positions, are presented to the user in ranked order.

### Atom-Pair Selection Method Without Linkers

Similar methods are used for base-atom selection and tip-atom selection.

### Use for Base-Atom Selection

Usually, a protocore compound has more potential attachment bonds than have been specified on the reference compound, and in such cases we identify a base atom on the protocore compound with each base atom on the reference compound, thus selecting a subset of the base atoms of the protocore compound. However, the algorithm works in the same manner when the protocore compound has fewer attachment bonds than the reference compound, or the same number. The procedure is as follows:
1. For each base atom on the reference compound and the protocore compound, initialize a counter with the number of attachment vectors it is associated with.
2. Compute the distance between each base atom on the reference compound and each base atom of the protocore compound. If there are N base atoms on the reference compound and M on the protocore compound, there will be N×M such distances.
3. Sort the list of distances, maintaining a record of which base-atom pair each is associated with.
4. Traverse the list of distances from smaller to larger distances.
   a. If either base atom's counter is zero, skip this distance.
   b. Otherwise, add the base pair associated with this distance to the growing list of base-atom pairs and decrement each base atom's counter by one.
5. Terminate when the size of the assembled list of base-atom pairs is equal to the smaller of the number of base atoms on the reference compound and the number on the protocore compound; or, if those numbers are equal, that number.

This algorithm gives preference to base-atom pairs (one each on the reference compound and the protocore compound) that are closest together and accommodates situations, such as that shown in FIG. 3, where some base atoms on the reference compound or the protocore compound or both are associated with multiple attachment bonds.

### Use for Tip-Atom Selection

When either or both base atoms in a corresponding pair, one from the reference compound and one from the protocore compound, are associated with multiple attachment bonds, a modification of the method described above is used to determine which tip atom(s) associated with the reference compound's base atom are to be paired with which on the protocore compound. The method is carried out separately for each such base-atom pair. No counters are needed, since each tip atom is connected to a single base atom. The list of distances is created using the tip atoms from the two base atoms in the pair; if the reference compound's base atom bears N attachment bonds and the protocore compound's base atom bears M, there will be N×M distances in the list. The method then proceeds as described above, except that Step 1 is omitted and in Step 4, no distances are skipped. In Step 5, the method terminates when the number of tip atoms already selected is equal to the smaller of the number of attachment bonds associated with the two base atoms in the pair currently under consideration.

Core Hopping with Linkers

We now describe the use of linkers. Linkers may be used with the core hopping method described above, but they may also be used more generally with other core hopping methods. For concreteness, we describe their use in the context of the above core hopping method.

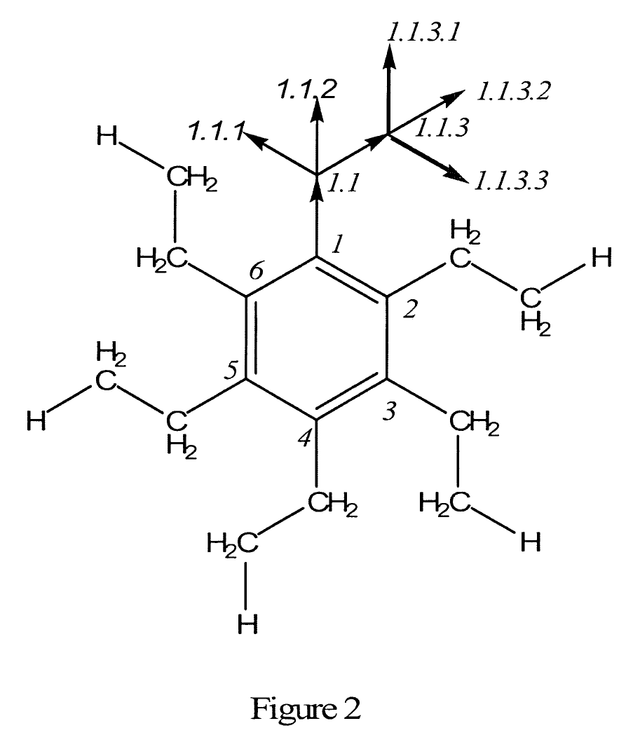

When linkers are to be used, regardless of the specific core hopping method used, the user specifies the maximum number of linkers that may be accepted in any attachment bond. This maximum number is inserted into every attachment bond on each protocore compound, forming an augmented protocore compound. In FIG. 1b, benzene is shown as a sample protocore compound. In FIG. 1c, two methylene linkers have been inserted into each bond to hydrogen, replacing each hydrogen with an ethyl group. This is the augmented protocore compound. In practice, the user may specify that only specific bonds in the protocore compound are to be considered attachment bonds, but the default is to use all bonds to hydrogen as shown. FIG. 2 elaborates FIG. 1c by making the hydrogens explicit, and for one ethyl group resulting from the insertion of two linkers, the full structural formula is shown. For this ethyl group, each atom is shown with a label using a scheme that facilitates atom-pair selection when linkers are in used, as described below. This defines a tree of attachment bonds that replaces each attachment bond of the original protocore compound. Only one ethyl group is shown in full in FIG. 2, with its labels. The attachment bonds are shown with arrows drawn from each attachment bond's base atom to its tip atom. The other ethyl groups have similar structures and labels, differing only in the first component of the labels (the number that appears to the left of the first decimal point). These are as shown in FIG. 2 for the base atoms on the central portion of the protocore compound.

As shown in FIG. 2, in each branch of attachment bonds, some atoms can serve only as tip atoms, some can serve as either base or tip atoms, and one—namely, the root base atom of the original attachment bond into which the linkers have been inserted—can only serve as a base atom. Given an atom in an augmented protocore compound and its label using the scheme shown in FIG. 2, the label of its root base atom will be the first component of its label; that is, the part that appears before the first decimal point. Its branch is denoted by the first two components of its label; that is, the part that appears before the second decimal point (or the entire label if there is only one decimal point). All attachment bonds in an augmented protocore compound contained within a linker tree derived from insertion into a given attachment bond on the original protocore compound share the same branch. Since no root base atoms in FIG. 2 bear multiple attachment points, each base atom in FIG. 2 gives rise to only a single branch; however, the base atom in FIG. 3 that bears side chains R′ and R″ would give rise to two branches upon insertion of linkers.

When linkers are used, we attempt, as before, to align the attachment bonds on the reference compound with a set of those on the protocore compound, but now there are many more possibilities. The benzene molecule shown in FIG. 1b has six attachment bonds; once linkers are added, there are 21, as implied by FIG. 2. Furthermore, if we are trying to match a reference compound that has three attachment bonds, such as the one shown in FIG. 1a, subsets of three attachment bonds sampled from the 21 shown in FIG. 2 present a richer range of sizes and geometries than subsets of three taken from the six associated with the benzene molecule in FIG. 1b. Thus, addition of linkers allows an augmented protocore compound to match a wider variety of reference compounds than the original protocore compound could match.

Rules for Attachment Bonds with Linkers

The following rules ensure that when linkers are used, a set of attachment bonds divides a compound into a central portion and peripheral atoms or peripheral molecular fragments, such that each attachment bond has a unique peripheral atom or peripheral molecular fragment associated with it:
1. Each attachment bond is a chemical bond with specified base and tip atoms.
2. No attachment bond is in a ring.
3. If any attachment bond were cleaved, the molecular fragment containing its tip atom would not contain the base or tip atom of anv other attachment bond in a different branch
   Protocore Compound Alignment and Selection Method with Linkers

The protocore compound alignment and selection method described above does not change when linkers are used. As a matter of terminology only, augmented protocore compounds, rather than protocore compounds, are used when linkers are present.

Atom-Pair Selection Method with Linkers

The atom-pair selection method, however, is altered slightly. The base atoms used from the protocore compound are all the eligible base atoms in all the linker chains. As described above for use without linkers, each base atom gets a counter which is initialized to the number of attachment bonds it is associated with. When linkers are in use, only the root base atoms get such counters. In addition, for each branch in the augmented protocore compound, we track whether a non-root base atom has already been selected from that branch. If so, we do not use another one from the same branch. This results in modifications of Steps 1 and 4 of the atom-pair selection method described earlier, as follows:
1. Initialization of counters:
   a. For each base atom on the reference compound and each root base atom on the augmented protocore compound, initialize a counter with the number of attachment vectors it is associated with.
   b. For each branch on the augmented protocore compound, initialize a Boolean variable to False, indicating that the branch has not yet been used.
4. Traverse the list of distances from lower to higher.
   a. If the counter of either the reference compound's base atom or the current augmented protocore compound's root base atom is zero, skip this distance.
   b. Otherwise, if the augmented protocore compound's base atom is not a root base atom and its branch's Boolean variable is True, indicating that the branch has already been used, skip this distance.
   c. Otherwise, add the pair of base atoms associated with this distance to the growing list of base-atom pairs, decrement the counters associated with the reference compound's and the current augmented protocore compound's root base atoms by one, and, if the augmented protocore compound's current base atom is not a root base atom, set its Boolean variable to True.

This method ensures that only a single base atom on any linker tree in the protocore compound will be used in a given alignment against the reference compound. An exception is made for root base atoms which, as before, can be used more than once. In addition, a root base atom can be used along with base atoms on its branches, in order to accommodate situations like the one shown in FIG. 3, where some base atoms have multiple branches.

Tip-Atom Pair Selection Method with Linkers

The tip-atom alignment method changes in only a minor way when linkers are used. If one selected base atom is a root base atom and another is a non-root base atom on a branch associated with the selected root base atom, the root base atom's tip atom may not be selected to be on that branch. This accommodates situations such as that shown in FIG. 3, where a single root base atom is associated with multiple branches, when linkers are in use.

Advantages of this Linker-Addition Method

When carried out in the context of the protocore compound alignment and selection method described above, use of linkers does not require a combinatorial traversal of possible linker or base-atom combinations. For each protocore compound, only a single compound, the augmented protocore compound, is used for alignment to the reference compound. Each alignment selects, in a single step, the set of base atoms that is optimal in the sense of the atom-pair selection method described above, and the atom-pair selection method scales linearly (not combinatorially) with the number of attachment bonds. The selected set of base atoms defines which linkers, if any, are used in the current alignment. The avoidance of a combinatorial search over base atoms or linker subsets recommends the disclosed method of linker addition in the context of the disclosed protocore compound alignment and selection method, which also avoids combinatories. However, the same method of linker addition and the same atom-pair selection method can also be used in the context of other protocore compound alignment and selection methods, including methods that are combinatorial in nature, such as that of Lauri and Bartlett cited earlier.

### EXAMPLE

This example demonstrates both aspects of this invention: the use of linkers and the use of our core-hopping method. The effect of the algorithm is illustrated by the following example, which finds a replacement for the flexible central portion of a triazine modulator of estrogen receptor beta activity. The crystal structure used for the study was INDE, described in [Henke, B. R., et al., “A New Series Of Estrogen Receptor Modulators That Display Selectivity For Estrogen Receptor Beta”; J. Med. Chem., 2002, 45, 5492-5505]. We obtained the coordinates of the INDE structure from the Protein Data Bank [Berman, H. M., et al., “The Protein Data Bank”, Nucleic Acids Res., 2000, 28, 235-242)].

FIGS. 4a through 4f show core regions in the same frame of reference, defined by the surrounding rectangles, and are projections of three-dimensional views.

FIG. 4a shows the structure of the triazine modulator. The bonds shown as heavy lines separate the side chains from the central core portion that the user wishes to replace. The core thus defined contains a total of ten rotatable bonds: four on the chain connecting the triazine ring to the phenolic group, five on the chain connecting the triazine ring to the chlorophenyl group, and one connecting the triazine ring to the piperazine ring. The goal of the study was to find a replacement for this central section that would have fewer rotatable bonds.

FIG. 4b shows the structure of indazole, which was included in the protocore compound library that we screened against the triazine reference compound shown in FIG. 4a. When performing this screen, we used the default choice for candidate attachment bonds; namely, bonds to hydrogen. These are shown explicitly.

In this study, we requested that a maximum of two linker methylenes be allowed in each attachment bond. FIG. 4c shows the augmented protocore compound that results. Hydrogen atoms are explicitly displayed as unlabeled terminal atoms. The carbon atoms of the added methylene linkers are shown as filled circles.

FIG. 4d depicts the final protocore compound that resulted from selecting attachment bonds in the augmented protocore compound that optimally align with those of the reference structure. Linkers that do not intervene between these bonds and the core of the augmented protocore compound have been deleted. The only hydrogens shown are those that serve as tip atoms in the selected attachment bonds. The selected attachment bonds are displayed with heavy lines and carbons derived from methylene linkers are shown as filled circles.

FIG. 4e is the optimized compound that was obtained by adding the side chains of the reference compound to the corresponding attachment bonds of the final protocore compound and optimizing side-chain degrees of freedom so as to optimize the alignment of the side-chains with those of the reference compound. Linker carbon atoms are again shown as filled circles.

FIG. 4f shows the optimized compound superimposed on the reference compound inside a surface representation of the I NDE binding site. The optimized compound is displayed as in FIG. 4e whereas the reference compound is displayed with light grey tube bonds. Heteroatoms are not labeled but can be identified by comparison with FIGS. 4a and 4e.

Several aspects of the results are noteworthy:
The algorithm selected four of the six linkers from the augmented protocore compound shown in FIG. 4c for use in the final protocore compound shown in FIG. 4d. Two each were used to connect the indazole core to the phenol and chlorophenyl rings; none was used in the connection to the piperazine ring.
The algorithm selected the orientation of the indazole core with respect to the core of the reference compound: it selected which core atoms on the indazole to use as root base atoms for ultimate attachment of linkers and side chains in the optimized compound.
The structure shown in FIG. 4e has seven rotatable bonds, three in each of the chains connecting the original indazole core to the aromatic rings and one connecting it to the piperazine ring. There were ten in the original triazine modulator shown in FIG. 4a. Thus, the goal of replacing the core of the original modulator with a less flexible core, while still positioning the side chains correctly, has been achieved.

Evaluation of the docked conformation shown in FIG. 4e with Glide [Friesner, et al. and Halgren, et al., cited earlier] indicates a good likelihood that this compound will bind well. This is a further indication of success.

A number of embodiments of the invention have been described. Nevertheless, it will be understood that various modifications may be made without departing from the spirit and scope of the invention.

What is claimed is:

1. In a computer-aided method of designing a final protocore compound based at least in part on overlap with a reference compound, the method which comprises the following steps without implying any order to those steps:
a) providing data for said reference compound in a specified chemically reasonable configuration, said reference compound data including a set of attachment bonds, each of said attachment bonds being a bond between a reference compound base atom in the core region of the reference compound and a tip atom on a side chain of said reference compound, said attachment bonds thereby partitioning the reference compound into a core region and side chains, each said side chain being associated with one of said attachment bonds;
b) providing data for a protocore compound, said protocore compound data including a set of attachment bonds, each of said attachment bonds being a bond between a protocore compound base atom in the core region of the protocore compound and a tip atom that is either a peripheral atom of said protocore compound or part of a peripheral molecular fragment of said protocore compound, said attachment bonds thereby partitioning the protocore compound into a core region and peripheral atoms or peripheral molecular fragments, each said peripheral atom or peripheral molecular fragment being associated with one of said attachment bonds;
c) providing data for linker compounds, each said linker compound including two attachment bonds, each of said attachment bonds being a bond between a base atom in the linker portion of the linker compound and a tip atom that is either a peripheral atom of said linker compound or part of a peripheral molecular fragment of said linker compound, said attachment bonds thereby partitioning the linker compound into a core region and peripheral atoms or peripheral molecular fragments, each said peripheral atom or peripheral molecular fragment being associated with one of said attachment bonds;
d) deriving data for an augmented protocore compound which includes at least one linker inserted into at least one attachment bond of the protocore compound, thereby creating additional attachment bonds within the augmented protocore compound;
e) comparing data for said reference compound with data for said augmented protocore compound to determine alignments between attachment bonds of the reference compound and attachment bonds of the augmented protocore compound, each alignment comprising pairs of attachment bonds, one attachment bond in each said pair being an attachment bond of said reference compound and the other attachment bond in each such pair being an attachment bond of said augmented protocore compound, the number of said pairs being the smaller of the number of attachment bonds in the reference compound and the number of attachment bonds in the original protocore compound, or, if these numbers are equal, that number, each such alignment thereby creating a selection of attachment bonds from the augmented protocore compound;
f) evaluating each said alignment and
if said alignment fails to fulfill one or more predetermined alignment criteria, reject said alignment and evaluate another alignment;
if said alignment fulfills said predetermined alignment criteria, accept said alignment and proceed to step g);
g) deriving a final protocore compound for each alignment accepted in step f), said derivation comprising:
i) removing all linkers in said augmented protocore compound that do not lie on a path connecting the core of the original protocore molecule and the attachment bonds of said augmented protocore molecule selected in step e);
ii) retaining as the attachment bonds of the final protocore compound only the selection of attachment bonds created in step e).

2. The method of claim 1 in which the steps e) and/or f) comprise, at least in part, use of data from a binding partner of the reference compound to ensure that any said alignment in which said augmented protocore compound interacts unfavorably with said binding partner is rejected.

3. The method of claim 1 further comprising,
h) attaching tip atoms of each of said reference compound side chains to base atoms of corresponding attachment bonds of said final protocore compounds in a chemically reasonable configuration, thereby generating optimized compounds;
i) comparing data for said optimized compounds with said reference compound and optionally with data for a binding partner of the reference compound, and
j) selecting one or more optimized compounds based at least in part on said data comparison of step i).

4. The method of claim 1 in which no two selected attachment bonds of the final protocore compound of step g) are in the same branch, thereby ensuring that at most one attachment bond of said final protocore compound is associated with linkers originally inserted into any single attachment bond on the original protocore compound.

5. The method of claim 1 in which, prior to step d), protocore compounds that possess fewer attachment bonds than the number of attachment bonds on the reference compound are discarded.

6. The method of claim 1 in which step d) comprises a process in which,
a) an attachment bond of the protocore compound is cleaved;
b) both attachment bonds of the linker compound are cleaved and the linker tip atoms discarded;
c) the base atom of the linker's first cleaved attachment bond is connected to the base atom of the protocore compound's cleaved attachment bond in a chemically reasonable configuration, creating an attachment bond whose base atom remains the base atom of the protocore compound's cleaved attachment bond and whose tip atom is the base atom of the linker's first cleaved attachment bond;
d) the base atom of the linker's second attachment bond is connected to the tip atom of the protocore compound's cleaved attachment bond in a chemically reasonable conformation, thereby creating an additional attachment bond whose base atom is the base atom of the linker's second cleaved attachment bond and whose tip atom is the tip atom of the protocore compound's cleaved attachment bond, thus creating an augmented protocore compound;
e) optionally, additional attachment bonds are defined whose base atoms are linker atoms and whose tip atoms are peripheral atoms or atoms belonging to peripheral molecular fragments of said linker compound, thus creating a further augmented protocore compound;
f) optionally, steps a) through e) are repeated for other attachment bonds on the original protocore compound, thus creating a further augmented protocore compound.

7. The method of claim 6 further comprising insertion of additional linkers into attachment bonds created by the first performance of steps a)-d) and optionally steps e) and or f) of claim 6, said additional linker insertion being carried out by the method of claim 6, thereby creating a further augmented protocore.

8. The method of claims 1, 6 and 7 in which step g) of claim 1 comprises, for each linker to be removed:
a) severing both attachment bonds to said linker created by carrying out the methods of claims 6 and 7, creating three atoms and/or molecular fragments;
b) discarding the molecular fragment thus created that includes said linker;
c) creating a bond in a chemically reasonable configuration between the two other atoms and/or molecular fragments created in step a).

9. The method of claim 1 in which the linkers tested include one more of the following: methylene, ethylene, o, m, p-phenylene, ethers, carbonyls, amines and amides.

10. The method of claim 1 in which the alignments in steps e) and f) are determined and evaluated in two stages:
a) first, the base atoms of the attachment bonds of the augmented protocore compound that will participate in said alignment are selected and associated with corresponding base atoms of the reference compound, and this correspondence is evaluated, and if this correspondence fails to fulfill one or more predetermined criteria, said correspondence is rejected and another base-atom correspondence is evaluated; otherwise,
b) for each said selected base atom of the augmented protocore compound, a unique tip atom associated with one of its attachment bonds is selected, thus completing the determination of the attachment-bond pairs comprised by said alignment.

11. The method of claim 10 in which step f) of claim 1 comprises performing a rigid body superposition of the selected base atoms of the augmented protocore compound on the corresponding base atoms of the reference compound after the operation of step a) of claim 10 and prior to the operation of step b) of 10.

12. The method of claim 10 in which step f) of claim 1 comprises energetic minimization with the use of constraints to attempt to superimpose the selected base atoms of the augmented protocore compound on the corresponding base atoms of the reference compound after the operation of step a) of claim 10 and prior to the operation of step b) of 10.

13. The method of claim 12 in which the specified configuration of the reference compound is its configuration when docked with a binding partner for the reference compound, and the energetic minimization is carried out in in a binding site of the binding partner.

14. The method of claim 13 in which the binding partner is a biological target.

15. The method of claim 2 in which step c) and/or f) is carried out with detection and enforcement of at least one constraint on the augmented protocore compound defined with respect to the binding partner, and
if a predetermined number of constraints cannot fulfilled by the pose of the augmented protocore compound, that pose is rejected.
if a predetermined number of constraints cannot be fulfilled by any pose of the augmented protocore compound, that augmented protocore compound is rejected.

16. The method of claim 15 in which the constraint is a conserved hydrogen-bonding or hydrophobic interaction.

17. The method of claim 15 in which the constraint is derived from the core of the reference compound in its configuration when docked with said binding partner.

18. The method of claim 10 in which step f) of claim 1 comprises determining the residual interatomic displacements between the base atoms of the reference compound and the base atoms of the augmented protocore compound's attachment bonds selected and aligned in step a) of claim 10, and an overall score is defined, comprising either the worst such displacement for any pair or some collective measure of displacement, such as root-mean-square of the displacements for all the pairs, and if the overall score is above a predetermined maximum, reject the current base-atom pairing and perform said evaluating step on a different selection and permutation of base atoms selected from the augmented protocore compound in its current or in a different conformation;
if the overall score is below said maximum, determine whether there are multiple candidate tip atoms for any of the currently selected base atoms and, if so, determine the best tip atom for each side chain.

19. The method of claim 10 in which step b) comprises a determination, for each base atom selected in step a), of which connected tip atom is the best geometric match for the tip atom of the corresponding attachment bond of the reference compound, in which the score of an individual match is based on interatomic displacement or upon base-tip vector comparison, as follows:
if the geometric criterion is interatomic displacement, the geometric criterion will be that the observed displacement, carried out using a common bond length for the base-tip bond lengths on corresponding reference and protocore compound candidate attachment bonds, must be less than a predetermined value;
if the geometric criterion is vector alignment, the geometric criterion will be that the cosine of the angle between the vectors being compared must exceed a predetermined value;
once the best scoring tip atom for each attachment bond has been found, an overall geometric score can be computed, said overall score comprising a collective measure, such as the average or root-mean-square, of the scores of the individual matches, or, alternatively, the worst of the scores of the individual matches, and
if the overall score does not fulfill a predetermined criterion, proceed to a different conformation of the augmented protocore compound, or to a different selection or permutation of the augmented protocore compound's attachment bonds;
if the overall score does fulfill a predetermined criterion, save the current protocore compound, selected set of linkers, conformation and attachment vectors as a final protocore compound;

20. The method of claim 3 in which step i) further comprises an evaluation of whether the side chains of said optimized compound can closely adopt the positions that they had in the reference compound.

21. The method of claim 3 in which step i) further comprises an evaluation of whether said optimized compound is likely to bind well to a binding partner of the reference compound using a docking score.

22. The method of claim 3 in which step i) is carried out with detection and enforcement of at least one constraint on the optimized compound defined with respect to the binding partner,
if the constraint cannot fulfilled by the pose of the optimized compound, that pose is rejected.
if the constraint cannot be fulfilled by any pose of the optimized compound, that optimized compound is rejected.

23. The method of claim 22 in which the constraint is a conserved hydrogen-bonding or hydrophobic interaction.

24. The method of claim 22 in which the constraint is derived from the reference compound in its configuration when docked with said binding partner.

25. The method of claim 10 in which step a) is carried out at least in part by sampling multiple conformations and spatial positions and orientations for the augmented protocore compound, computing distances between the base atoms of the reference compound and the base atoms of the protocore compound, and selecting a number of corresponding base atom pairs, each pair comprising one base atom on the reference compound and one base atom on the protocore compound.

26. The method of claim 1 in which step a) provides data for said reference compound in multiple configurations, and the method is repeated for each configuration.

27. In a computer-aided method of designing a final protocore compound based at least in part on overlap with a reference compound, the method which comprises the following steps without implying any order to those steps:
a) providing data for said reference compound in a specified chemically reasonable configuration, said reference compound data including data including a set of attachment bonds, each of said attachment bonds being a bond between a reference compound base atom in the core region of the reference compound and a tip atom on a side chain of said reference compound, said attachment bonds thereby partitioning the reference compound into a core region and side chains, each said side chain being associated with one of said attachment bonds;
b) providing data for a protocore compound, said protocore compound data including including a set of attachment bonds, each of said attachment bonds being a bond between a protocore compound base atom in the core region of the protocore compound and a tip atom that is either a peripheral atom of said protocore compound or part of a peripheral molecular fragment of said protocore compound, said attachment bonds thereby partitioning the protocore compound into a core region and peripheral atoms or peripheral molecular fragments, each said peripheral atom or peripheral molecular fragment being associated with one of said attachment bonds;
c) comparing data for said reference compound with data for said protocore compound to determine whether a set of attachment bonds of said protocore compound align with a set of attachment bonds of the reference compound when the protocore compound is in a chemically reasonable conformation, said comparison comprising:
i) sampling the chemically reasonable conformations of said protocore compound,
ii) placing the chemically reasonable conformations of said protocore compound in a variety of positions and orientations in space with regard to the reference compound,
iii) deriving a list of atom pairs to use in aligning the protocore compound with the reference compound, based on spatial proximity of atoms belonging to the attachment bonds of said reference compound to atoms belonging to the attachment bonds of said protocore compound in its currently sampled conformation, spatial position and orientation;
iv) moving the protocore compound in space so as to optimize the alignment of said atom pairs,
v) evaluating, for said optimized alignment, a measure of alignment between the attachment bonds on the reference compound and the corresponding attachment bonds on the protocore compound;
Optionally, in steps c) i) through c) v), data from a binding partner of the reference compound may be used to ensure that said aligned protocore compound interacts favorably with said binding partner; and
d) deriving one or more final protocore compounds based at least in part on 30 said data comparison of step c), said derivation comprising selection of a set of attachment bonds on the reference compound aligned with corresponding attachment bonds on the protocore compound.

28. The method of claim 27 in which an augmented protocore compound is derived from a protocore compound by means of linker addition into the attachment bonds of the protocore compound and is subjected to c) and d) of claim 27 to generate final protocore compounds.

29. The method of claim 27 or 28 further comprising:
e) attaching tip atoms of each of said reference compound side chains to base atoms of corresponding attachment bonds of said final protocore compounds in a chemically reasonable configuration, thereby generating optimized compounds;
f) comparing data for said optimized compounds with said reference compound and optionally with data for a binding partner of the reference compound, and
g) selecting one or more optimized compounds based at least in part on said data comparison of step i).

30. The method of claim 27 in which the atom pairs derived in step c) iii) consist of pairs of base atoms of attachment bonds, one base atom in each said pair being the base atom of an attachment bond in the reference compound and the other base atom in each said pair being the base atom of an attachment bond in the protocore compound.

31. The method of claim 30 in which the derivation of the atom pairs is further carried out by the following method:
a) for each base atom on the reference compound and each base atom on the protocore compound, initialize a counter with the number of attachment bonds it is associated with;
b) initialize an empty list of base-atom pairs that will be filled by the procedure described below with corresponding pairs of base atoms, each said pair consisting of one base atom from the reference compound and one base atom from the protocore compound;
c) compute the distance between each base atom on the reference compound and each base atom of the protocore compound, and place said distances in a list, maintaining a record of which base atom from the reference compound and which base atom from the protocore compound each said distance is associated with;
d) sort said list of distances, maintaining said record of which base atom from the reference compound and which base atom from the protocore compound each said distance is associated with;
e) evaluate each member of said list of distances in order from smaller to larger distances, and
i) if the counter is zero for the base atom belonging to the reference compound that is associated with this distance, skip this distance;
ii) if the counter is zero for the base atom belonging to the protocore compound that is associated with this distance, skip this distance;
iii) otherwise, add the two base atoms associated with this distance as a new pair on the list of base-atom pairs, and decrement the counters of both said base atoms by one;
f) terminate the process when the number of pairs in the list of base-atom pairs is equal to the smaller of the number of attachment bonds on the reference compound and the number of attachment bonds on the protocore compound; or, if said numbers are equal, that number.

32. The method of claim 31 in which, prior to step c) of claim 1, protocore compounds that possess fewer attachment bonds than the number of attachment bonds on the reference compound are discarded.

33. The method of claim 27 in which step c) iv) comprises performing a rigid-body motion of the protocore compound so as to attempt to superimpose the pairs of corresponding atoms given in the atom pairs derived in step c) iii).

34. The method of claim 27 in which step c) iv) comprises energetic minimization with the use of constraints to attempt to superimpose the pairs of corresponding atoms given in the atom pairs derived in step c) iii).

35. The method of claim 34 in which the specified configuration of the reference compound is its configuration when docked with a binding partner for the reference compound and the energetic minimization is carried out in a binding site of the binding partner.

36. The method of claim 35 in which the binding partner is a biological target.

37. The method of claim 35 in which the energetic minimization is further carried out with detection and enforcement of at least one constraint on the protocore compound defined with respect to the binding partner;
if a predetermined number of constraints cannot fulfilled by the pose of the protocore compound, that pose is rejected.
if a predetermined number of constraints cannot be fulfilled by any pose of the protocore compound, that protocore compound is rejected.

38. The method of claim 37 in which the constraint is a conserved hydrogen-bonding or hydrophobic interaction.

39. The method of claim 37 in which the constraint is derived from the core of the reference compound in its configuration when docked with said binding partner.

40. The method of claim 30 in which step c) v) of claim 27 comprises determining the residual interatomic displacement between the atom pairs derived in claim 30, following the alignment of step c) iv) of claim 27, and an overall score is defined, comprising either the worst such displacement for any pair or some collective measure of displacement, such as root-mean-square of the displacements for all the pairs, and
if the score is above a predetermined maximum, reject the current alignment and perform said evaluating step on another alignment of the protocore compound based on a new spatial sample obtained from step c) ii) of claim 27 or, if spatial sampling is complete, on a spatial sample from a new conformation of the protocore compound obtained from step c) i) of claim 27;
if the score is below said maximum, determine whether there are multiple tip atoms for any of the base atoms in said atom pair, and if so, determine the best tip atom for each base atom in each of said atom pairs.

41. The method of claim 40 further comprising a determination, for each base atom in an attachment bond of the protocore compound, which connected tip atom is the best geometric match for the tip atom on the base atom of the corresponding attachment bond of the reference compound, the score of an individual match being based on interatomic displacement or upon base-tip vector comparison, as follows:
if the geometric criterion is interatomic displacement, the geometric criterion will be that the observed displacement, carried out using a common bond length for the base-tip bond lengths on corresponding reference and protocore compound candidate attachment bonds, must be less than a predetermined value;
if the geometric criterion is vector alignment, the geometric criterion will be that the cosine of the angle between the vectors being compared must exceed a predetermined value;
once the best scoring tip atom for each attachment bond has been found, an overall geometric criterion can be computed; this comprises a collective measure, such as the root-mean-square or the average, of the scores for all the attachment bonds or alternatively the worst of the scores for all the attachment bonds,.
if the overall geometric match does not fulfill a predetermined criterion, proceed to a different conformation of the protocore compound, or to a different selection or permutation of the protocore compound's attachment bonds;
if the overall geometric match does fulfill a predetermined criterion, save the current protocore compound, selected set of linkers, conformation and attachment vectors as a final protocore compound;

42. The method of claim 29 in which step f) further comprises an evaluation of whether the side chains of said optimized compound can closely adopt the positions that they had in the reference compound.

43. The method of claim 29 in which step f) further comprises an evaluation of whether said optimized compound is likely to bind well to a binding partner of the reference compound, at least in part by means of evaluation of a docking score.

44. The method of claim 43 in which the evaluation is further carried out with detection and enforcement of at least said one constraint on the optimized compound defined with respect to a binding partner of the reference compound;
if a predetermined number of constraints cannot be fulfilled by the a bound pose of the compound, that pose is rejected.
if a predetermined number of constraints cannot be fulfilled by any pose of the compound, that optimized compound is rejected.

45. The method of claim 44 in which the constraint is a conserved hydrogen-bonding or hydrophobic interaction.

46. The method of claim 44 in which the constraint is derived from the reference compound in its configuration when docked with said binding partner.

47. The method of claim 30 in which an augmented protocore, rather than an original protocore, is used in place of the protocore in claim 27, and in which the derivation of the atom pairs is further carried out by the following method:
a) initialize variables as follows:
i) for each base atom on the reference compound and each root base atom on the augmented protocore compound, initialize a counter with the number of attachment bonds it is associated with, and
ii) for each branch on the augmented protocore compound, initialize a Boolean variable to False, indicating that the branch has not yet been used;
b) initialize an empty list of base-atom pairs that will be filled by the procedure described below with corresponding pairs of base atoms, each said pair consisting of one base atom from the reference compound and one base atom from the augmented protocore compound;
c) compute the distance between each base atom on the reference compound and each base atom of the augmented protocore compound, and place said distances in a list, maintaining a record of which base atom from the reference compound and which base atom from the augmented protocore compound each said distance is associated with;
d) sort said list of distances, maintaining said record of which base atom from the reference compound and which base atom from the augmented protocore compound each said distance is associated with;
e) evaluate each member of said list of distances in order from smaller to larger distances, and
i) if the counter is zero for the base atom belonging to the reference compound that is associated with this distance, skip this distance;
ii) if the counter is zero for the root base atom belonging to the augmented protocore compound that is associated with this distance, skip this distance;
iii) otherwise, if the augmented protocore compound's base atom is not a root base atom and its branch's Boolean variable is True, skip this distance;
iv) otherwise, add the two base atoms associated with this distance as a new pair on the list of base-atom pairs, decrement the counters of both said base atoms by one, and, if the base atom belonging to the augmented protocore is not a root base atom, set its Boolean variable to True;
f) terminate the process when the number of pairs in the list of base-atom pairs is equal to the smaller of the number of attachment bonds on the reference compound and the number of attachment bonds on the augmented protocore compound; or, if said numbers are equal, that number.

48. The method of claim 27 in which step a) provides data for said reference compound in multiple configurations, and the method is repeated for each configuration.
